(19) United States
(12) Patent Application Publication
(10) Pub. No.: US 2009/0060296 A1
(43) Pub. Date: Mar. 5, 2009

(54) Sensor Security

(75) Inventor: Jean-Francois Mainguet, Grenoble (FR)

Correspondence Address: FISH & RICHARDSON P.C., PO BOX 1022, MINNEAPOLIS, MN, 55440-1022, US

(73) Assignee: ATMEL SWITZERLAND, Fribourg (CH)

(21) Appl. No.: 11/847,739

(22) Filed: Aug. 30, 2007

(51) Int. Cl. G06K 9/00

(52) U.S. Cl. 382/124

(57) ABSTRACT

The disclosure herein relates to biometric sensor device security. The biometric integrity of a stimulus; e.g., a finger, that is applied to a biometric sensor can be verified by the biometric sensor. Biometric data related to the stimulus can then be received from the biometric sensor. In order to be more resistant to spoofing techniques, the biometric sensor can monitor for an application continuity of the stimulus during the verifying and receiving steps.

### BACKGROUND

This disclosure relates to sensor security.

Sensor devices can include sensor manufactures that can transduce one form of energy into another, e.g., charged coupled devices, piezoelectric materials, or pyroelectric materials. Typically, such sensor devices include basic control circuitry, e.g., amplifiers, analog-to-digital converters, input/output circuitry, and the like, on device (e.g., on-chip).

The data output by the sensor device can be processed by a processing device in communication with the sensor device. The processing device can, for example, process the data received from the sensor device to reconstruct a fingerprint image and attempt to authenticate or identify the fingerprint. The authentication of the fingerprint can, for example, be used to access a secure area. However, the sensor device can be susceptible to spoofing by introducing a fake sample. For example, a cast made from a mold and material such as modeling clay or gelatin can be used to spoof the sensor device.

### SUMMARY

The disclosure herein relates to biometric sensor device security. The biometric integrity of a stimulus; e.g., a finger, that is applied to a biometric sensor can be verified by the biometric sensor. Biometric data related to the stimulus can then be received from the biometric sensor. In order to be more resistant to spoofing techniques, the biometric sensor can monitor for an application continuity of the stimulus during the verifying and receiving steps.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1A is a block diagram of an example sensor device system.

FIG. 1B is a block diagram of an example sensing device configured to monitor for an application continuity of the stimulus.

FIG. 1C is a block diagram of another example sensing device configured to monitor for an application continuity of the stimulus.

FIG. 1D is a block diagram of another example sensing device configured to monitor for an application continuity of the stimulus.

FIG. 1E is a block diagram of another example sensing device configured to monitor for an application continuity of the stimulus.

FIG. 2 is a flow diagram of an example sensor security process.

FIG. 3 is a flow diagram of another example sensor security process.

FIG. 4 is a flow diagram of an example process for monitoring for an application continuity of a stimulus.

### DETAILED DESCRIPTION

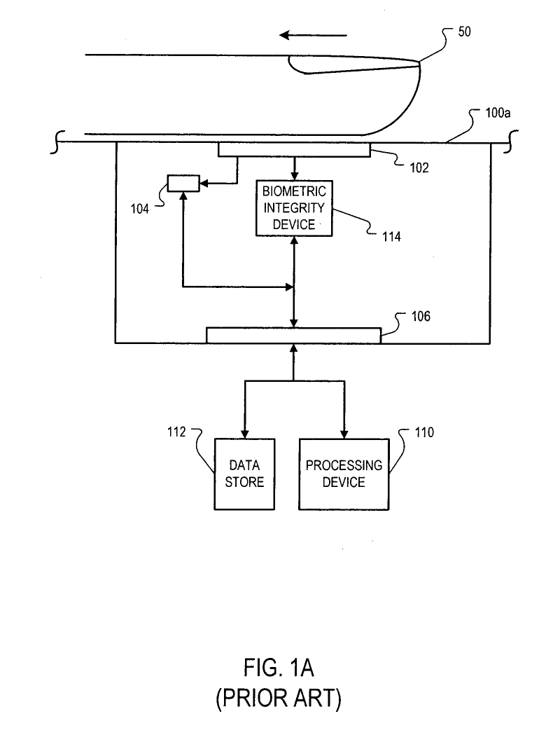

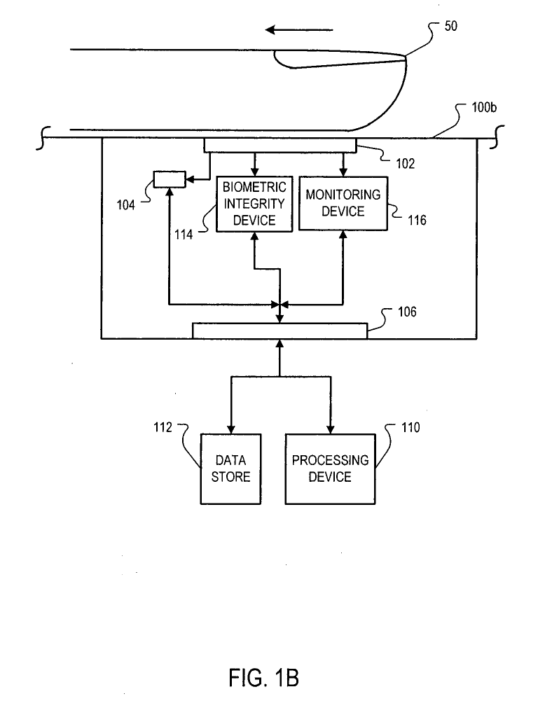

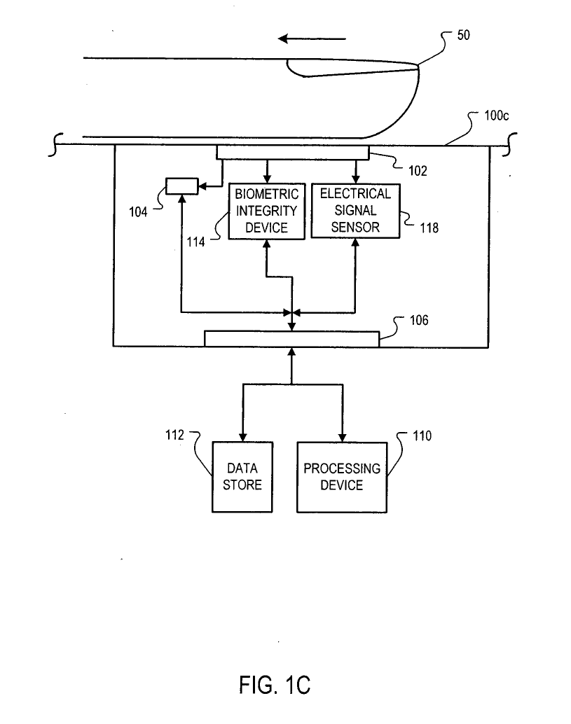

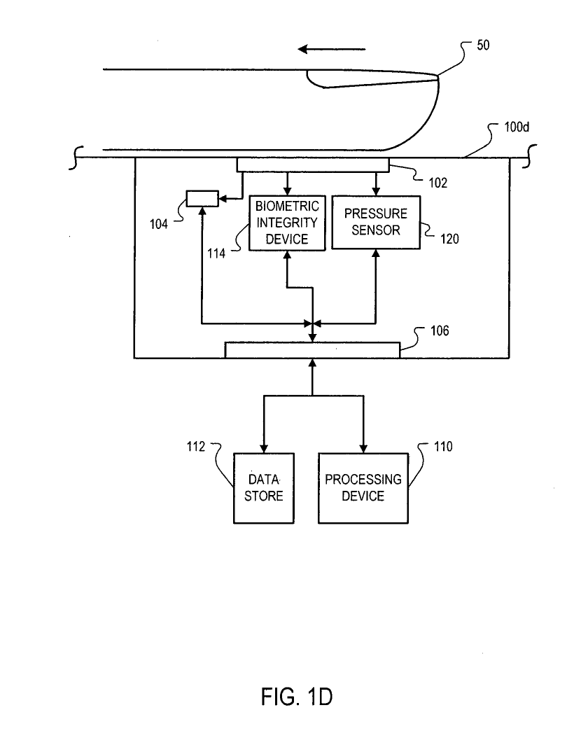

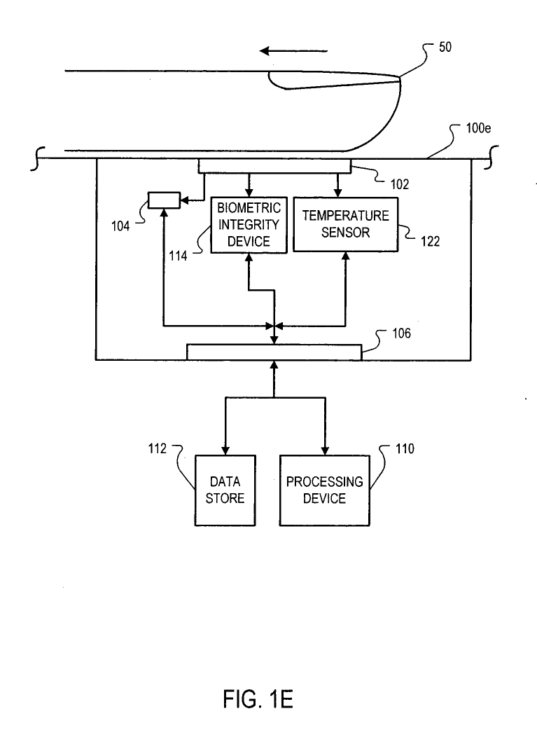

FIG. 1A is a block diagram of an example sensing device 100a. The sensing device 100a can be utilized to authenticate or determine a user's identity. For example, the sensing device 100a can be used to grant a user access to a restricted area. By way of example, reference will be made to a sensing device 100 that is of the form of a swipe fingerprint sensor. Other sensing devices can also be used, e.g., a fingerprint sensor configured to receive substantially the entire surface of a fingerprint and capture an image of the fingerprint.

In one implementation, a user's identity can be authenticated by utilizing a two-step process. In the first step, the sensing device 100a can verify a biometric integrity of a stimulus, e.g., a finger 50, applied to the sensing device 100a by sensing a living tissue characteristic, e.g., a cardiac pulse. The sensing device 100a can include a biometric integrity device 114 configured to verify the biometric integrity of the finger 50 by acquiring a cardiac pulse of the finger 50 applied to the biometric sensor 100b. In one implementation, a cardiac pulse can be acquired from the finger by utilizing an oximetry procedure. For example, the biometric integrity device 114 can be a pulse oximeter, which can conduct the oximetry procedure. Other devices can be utilized to verify the biometric integrity of the finger 50, such as a thermal sensor, a pressure sensor, an optical sensor, a silicon capacitance sensor, a capacitative fingerprint sensor, a surface impedance sensor, an acoustical sensor, etc.

In the second step, the sensing device 100a can read a swipe of the finger 50 in order to authenticate the fingerprint data associated with the finger 50. The sensing device 100a can include a sensor manufacture 102 coupled to a processing circuit 104 and an input/output circuit 106. Other forms of sensors are possible. As a finger 50 is swiped across the sensor manufacture 102 of the sensing device 100a, the sensor manufacture 102 can generate electrical signals based on the fingerprint on the finger 50. The electrical signals can be used to generate biometric data, e.g., image data or minutiae data, representative of the fingerprint of the finger 50, etc. The source material of the sensor manufacture 102 can, for example, comprise a layer of polyvinylidene fluoride (PVDF), polyvinylidene fluoride, trifluoroethylene (PVDF-TrFE), polyvinylidene cyanide-vinyl acetate (PVDCN-VAc), or some other transducing material that can produce an electric charge in response to a physical stimulus, such as a biometric stimulus.

The electrical signals output by the sensor manufacture 102 can be processed by the processing circuit 104. In one implementation, the processing circuit 104 can include an analog to digital converter and a latch. Other processing circuits can also be used. The output of the processing circuit 104 can be a digital representation of the fingerprint. The biometric data can be provided to an input/output circuit 106, which, in turn, can provide the biometric data to a processing device 110, such as a microprocessor executing filtering and recognition algorithms. In one implementation, a data store 112 can be coupled to the input/output circuit 106 and the processing device 110 and configured to store the biometric data received from the biometric sensor 100b.

The processing device 110 can execute a matching algorithm on the biometric data to determine whether a corresponding reference sample (e.g., fingerprint) can be identified or authenticated. The matching algorithm can, for example, perform a comparison of the biometric data received to one or more reference data sets, e.g., fingerprint templates. The reference data sets can, for example, be stored during a biometric enrollment process in which one or more users provide a biometric stimulus, e.g., a fingerprint application to a sensor device. An authentication or identification can be made if a match between the biometric data and one or the reference data sets is identified.

The sensing device 100a, however, can be spoofed by a user to overcome the two-step process. For example, a user can first apply a real finger to the sensing device 100a in order to verify that a finger has a living tissue characteristic, e.g., a cardiac pulse. Subsequently, a user can apply another stimulus, such as a fake fingerprint made of wax, for example, and swipe the artificial fingerprint on the sensing device 100a to authenticate fingerprint data.

For anti-spoofing purposes, the sensing device 100a can be configured to monitor for an application continuity of the stimulus, e.g., finger 50. FIG. 1B is a block diagram of an example sensing device configured to monitor for an application continuity of the stimulus. The sensing device 100b operates in a similar manner to the sensing device 100a; however, the sensing device 100b includes a monitoring device 116 that can be configured to monitor for an application continuity of the finger 50.

The monitoring device 116 of the sensing device 100b can monitor for an application continuity of the finger 50 while the finger 50 is pressed to the sensing device 100b to verify a biometric integrity, e.g., a cardiac pulse, of the finger 50 during a verifying step, and while the finger 50 is being swiped across the sensing device 100b during a data receiving step. Monitoring device 116 implementations can include an electrical signal sensor, a pressure sensor, and/or a temperature sensor that monitors for an application continuity of the biometric stimulus. In another implementation, the monitoring device 116 of the sensing device 100b can monitor for an uninterrupted application of the finger 50.

In some implementations, instructions can be provided to a user of the biometric sensor 100b. For example, a message can be displayed to the user to provide instructions regarding her use of the biometric sensor 100b. For example, the biometric sensor 100b can provide data that can be interpreted into message data and displayed through an LED device, a digital display, or some other display device to display instructions to the user. The message can, for example, notify the user to press her finger on the biometric sensor 100b to allow the biometric integrity device 114 a sufficient amount of time to verify a biometric integrity measurement, e.g., acquire a cardiac pulse of the finger 50. In another implementation, a color signal can be used to provide instructions to the user of the biometric sensor 100b. For example, a red LED may be illuminated to indicate to the user of biometric sensor 100b that she should continue to press her finger on the biometric sensor 100b. Other types of output devices can be used to provide instructions to a user of the biometric sensor 100b.

In some implementations, the sensing device 100b can generate a signal between the verifying and receiving steps to alert the user that the biometric integrity verification step is complete and that the user can proceed with the swiping, e.g., data receiving, step. For example, in response to determining that a cardiac pulse has been detected from the finger 50 applied to the biometric sensor 100b, the biometric integrity device 114 of the biometric sensor 100b can provide an indication to the user. The indication provided by the biometric sensor 100b can include a color signal, a message, or an audible alert.

In one implementation, the indication provided by the biometric sensor 100b can include a notification to proceed with a sensing event, e.g., a fingerprint swipe. For example, a user can press her finger 50 on the biometric sensor 100b until an indication is provided that a biometric integrity has been verified. The indication provided by the biometric sensor 100b can notify the user to swipe her finger across the biometric sensor 100b. In response to the indication, the user can proceed with swiping her finger across the biometric sensor 100b, without removing her finger from the biometric sensor 100b. For example, a red LED can be illuminated while the biometric integrity device 114 acquires a cardiac pulse from the finger, and the LED can turn to green when the cardiac pulse of the finger 50 is verified. In another implementation, a digital message can be displayed to the user to indicate that a cardiac pulse has been verified. In another implementation, an audible alert can be generated to notify the user that a cardiac pulse has been verified. Other types of indications can be provided by the biometric sensor 100b.

In another implementation, an indication can be provided to the user of the biometric sensor 100b that a biometric integrity was not verified from the finger 50 applied to the biometric sensor 100b. For example, an indication that an accurate cardiac pulse could not be read can be generated.

The biometric sensor 100b can be configured to generate an indication in response to identifying or authenticating the fingerprint of the finger 50. For example, in response to identifying the fingerprint of the finger 50 applied to the biometric sensor 100b, the biometric sensor 100b can provide an indication to the user has been approved by the biometric sensor 100b.

Monitoring for an application continuity of a biometric stimulus, e.g., finger 50, results in the biometric sensor 100b being more resistant to spoofing attempts, such as applying a fake finger, a cast of a finger made of clay, a wax finger, etc. Different algorithms can be used to determine whether a stimulus has been removed between the verifying and data receiving steps. For example, if the biometric sensor 100b determines that a measured value exceeds an electrical signal threshold, pressure threshold, and/or temperature threshold, the biometric sensor 100b can determine that the finger 50 has been removed, i.e., that the application of the finger has been interrupted. In another implementation, if the biometric sensor 100b determines that a difference in a measured value from one measurement to the next during discrete time periods differs by more than a threshold value, then the biometric sensor 100b can determine that the finger 50 has been removed. Other algorithms can also be used.

In one implementation, an indication that the finger does not maintain a continuous presence on the sensing device 100b between the two steps can be provided. The indication can be a color signal. In another implementation, the indication can be a digital message that can be displayed. In another implementation, the indication can be an audible alert, e.g., an alarm that can be generated.

In one implementation, the verifying and receiving steps can be repeated if the application of the finger is interrupted during the verifying and receiving steps. For example, the indication provided by the biometric sensor 100b can notify the user to repeat the steps of applying her finger 50 to the biometric sensor 100b, and swiping her finger across the biometric sensor 100b when she receives a notification that her cardiac pulse has been verified.

FIG. 1C is a block diagram of another example sensing device configured to monitor for an application continuity of the stimulus. In one implementation, the biometric sensor 100c can be configured to monitor for an application continuity of the finger 50 on the biometric sensor 100c by monitoring an electrical signal with an electrical signal sensor 118 at the biometric sensor 100c during the verifying and receiving steps. For example, the biometric sensor 100c can determine if the electrical signal exceeds an electrical signal threshold during the verifying and receiving steps. The monitored electrical signals can, for example, be an impedance, such as a resistance, a voltage, a current, and/or a capacitance.

In one implementation, the electrical signal sensor 118 can include one or more electrodes that are coupled to the biometric sensor 100c to monitor the electrical signals. For example, the electrodes can be distributed on the periphery of the sensor manufacture 102 such that the electrodes are in electrical communication with the finger 50 when the finger is applied to the sensor 100c. In one implementation, a measured electrical signal can be compared to an electrical signal threshold. For example, the electrical signal threshold can be predetermined based on a possible range of values that the monitored electrical signals may be measured at during the verifying and receiving steps. Based on the possible range of values, the electrical signal threshold can be defined by the maximum range value and the minimum range value that may occur during the verifying and receiving steps. In one implementation, the biometric sensor 100c can provide an indication when a measured electrical signal value exceeds the electrical signal threshold.

By way of example, living skin tissue can have a characteristic impedance that can be recognized. For example, a possible range of impedance values can be measured by the electrical signal sensor 118 when a finger is applied at the biometric sensor 100c. An impedance threshold can be predefined based on the recognized possible range of values. The predefined impedance threshold can indicate that the measured impedance value can be somewhere in the predefined range during the verifying and receiving steps. During the verifying and receiving steps, the impedance can be monitored at the biometric sensor 100c by the electrical signal sensor 118. While the impedance values fall within the recognized range, it can be determined that an interruption has not occurred. However, if the measured impedance value is outside the recognized range during the verifying and receiving steps, the biometric sensor 100c can, for example, indicate that the application of the finger 50 on the biometric sensor 100c has been interrupted.

In another implementation, the biometric sensor 100c can determine the percentage of time that the impedance values fall within the predefined impedance threshold for the total length of time the finger is applied at the biometric sensor 100c during the verifying and receiving steps. A threshold can be predefined that indicates an acceptable percentage that the impedance values fall within the predefine impedance threshold over the total length of time.

While the percentage of time that the impedance values fall within the predefined impedance threshold during the total length of time is greater than the acceptable percentage threshold, the biometric sensor can indicate a successful application continuity of the finger. However, if the percentage of time that the impedance values fall within the predefined impedance threshold during the total length of time is less than the acceptable percentage threshold, the biometric sensor 100c can, for example, indicate an unsuccessful application continuity of the finger on the biometric sensor 100c.

In another implementation, the electrical signal sensor 118 can determine if the electrical signal exceeds an electrical signal change threshold during the verifying and receiving steps. For example, an electrical signal change threshold can be defined as a maximum value that the electrical signal can change from one measured value to the next measured value during the verifying and receiving steps during discrete time periods. For example, when a user presses her finger 50 on the biometric sensor 100c, the measured electrical signal values should maintain continuity, without an abrupt change in the measured electrical signal values. In one implementation, the biometric sensor 100c can provide an indication when a measured electrical signal value changes from one measurement to the next in excess of the electrical signal change threshold.

Other example electrical signal sensors 118 that can be used to monitor an electrical signal at the biometric sensor 100c can include an optical sensor, a capacitance sensor, a surface impedance sensor, an acoustical sensor, etc.

FIG. 1D is a block diagram of another example sensing device configured to monitor for an application continuity of the stimulus. In one implementation, the biometric sensor 100d can be configured to monitor for an application continuity of the stimulus, e.g., finger 50, on the biometric sensor 100c by monitoring a pressure of the stimulus at the biometric sensor during the verifying and receiving steps. For example, the biometric sensor 100d can include a pressure sensor 120, such as a piezoelectric sensor, to monitor the pressure of the finger 50. When a pressure is applied to the biometric sensor 100d, the resulting pressure can cause a mechanical deformation and a displacement of charges. The displacement of charges can be proportional to the applied pressure. Therefore, the displacement of charges can be utilized to determine the applied pressure from the finger 50 on the biometric sensor 100d.

In one implementation, a pressure threshold can be determined. The pressure threshold can be defined based on determining a possible range of values that the monitored pressure may be measured at during the verifying and receiving steps. Based on the possible range of values, the pressure threshold can be defined by the maximum range value and the minimum range value that may occur during the verifying and receiving steps. In one implementation, the biometric sensor 100d can provide an indication when a measured pressure value exceeds the pressure threshold.

In another implementation, the pressure sensor 120 can monitor a pressure of the of the stimulus, e.g., finger 50, at the biometric sensor 100d during the verifying and receiving steps, and determine if the pressure imparted by the finger exceeds a pressure change threshold during the verifying and receiving steps. For example, a pressure change threshold can be defined as a maximum value that the pressure can change from one measured value to the next measured value during the verifying and receiving steps during discrete time periods. When a user presses her finger 50 on the biometric sensor 100d, the measured pressure values should maintain continuity, without an abrupt change in measured pressure values. In one implementation, the biometric sensor 100d can provide an indication when a measured pressure value changes from one measurement to the next in excess of the pressure change threshold. Other pressure sensing-based algorithms can also be used.

FIG. 1E is a block diagram of another example sensing device configured to monitor for an application continuity of the stimulus. In one implementation, the biometric sensor 100e can be configured to monitor for an application continuity of the stimulus, e.g., finger 50, on the biometric sensor 100e by monitoring a temperature of the stimulus at the biometric sensor 100e during the verifying and receiving steps. For example, the biometric sensor 100e can include a temperature sensor 122, such as a thermister, to monitor a temperature of the finger 50. A temperature sensor 122 that includes a thermister can convert changes in temperature into specific voltages. Therefore, the voltages can be utilized to determine the temperature of the finger 50 on the biometric sensor 100e.

In one implementation, a temperature threshold can be determined. For example, the temperature threshold can be defined based on determining a possible range of values that the monitored temperature may be measured at during the verifying and receiving steps. Based on the possible range of values, the temperature threshold can be defined by the maximum range value and the minimum range value that may occur during the verifying and receiving steps. In one implementation, the biometric sensor 100e can provide an indication when a measured temperature value exceeds the temperature threshold.

In another implementation, the temperature sensor 122 can monitor a temperature of the stimulus, e.g., finger 50, at the biometric sensor 100e during the verifying and receiving steps. For example, the temperature sensor 122 can determine if the temperature of the finger exceeds a temperature change threshold during the verifying and receiving steps. A temperature change threshold can be defined as a maximum value that the temperature can change from one measured value to the next measured value during the verifying and receiving steps during discrete time periods. For example, when a user presses her finger 50 on the biometric sensor 100e, the measured temperature values should maintain continuity, without an abrupt change in measured temperature values. In one implementation, the biometric sensor 100e can provide an indication when a measured temperature value changes from one measurement to the next in excess of the temperature change threshold.

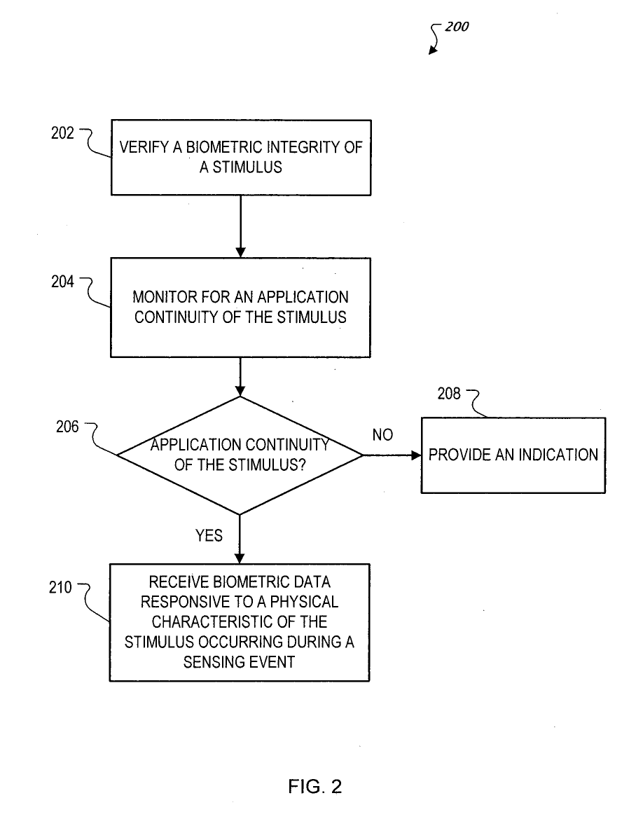

FIG. 2 is a flow diagram of an example sensor security process 200. The example process can, for example, be implemented in the sensor devices 100b, 100c, 100d, and 100e of FIGS. 1B, 1C, 1D and 1E, or in other biometric processing systems.

Stage 202 verifies a biometric integrity of a stimulus. For example, the biometric integrity device 114 can verify the biometric integrity of the stimulus, e.g., finger, applied to the biometric sensor 100b, 100c, 100d, and 100e.

Stage 204 monitors for an application continuity of the stimulus. For example, the monitoring device 116 can monitor for an application continuity of the finger during the verifying and receiving steps. The monitoring device 116 can, for example, measure electrical signals, such as an impedance, a voltage, a current, or a capacitance at an electrical signal sensor 118 to monitor for an application continuity of the finger during the verifying and receiving steps. The monitoring device 116 can, for example, also measure pressure with a pressure sensor 120 and temperature with a temperature sensor 122 to monitor for an application continuity of the finger during the verifying and receiving steps.

Stage 206 determines whether an interruption of the application of the stimulus has occurred based on the monitoring in stage 204. For example, if stage 204 determines that an interruption has occurred, stage 210 can provide an indication.

If Stage 204 determines that an interruption has not occurred, stage 208 receives biometric data responsive to a physical characteristic of the stimulus occurring during a sensing event. For example, the processing device 110 and the data store 112 can receive biometric data from the biometric sensor 100b, 100c, 100d, and 100e, and determine or authenticate the physical characteristic, e.g., fingerprint, of the stimulus, e.g., finger, occurring during a sensing event, e.g., fingerprint swipe.

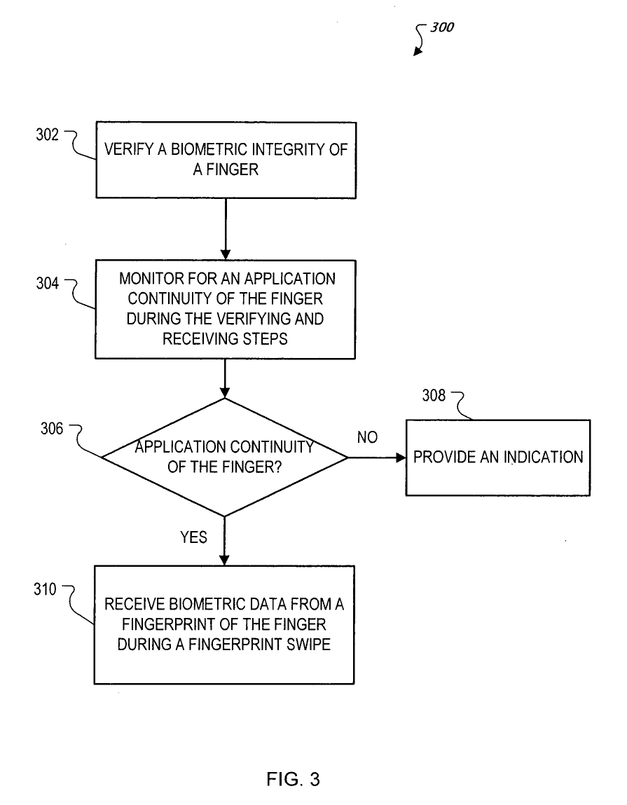

FIG. 3 is a flow diagram of an example sensor security process 300. The example process 300 can, for example, be implemented in the sensor devices 100b, 100c, 100d and 100e of FIGS. 1B, 1C, 1D and 1E, or in other biometric processing systems.

Stage 302 verifies a biometric integrity of a finger. For example, the biometric integrity device 114 can verify the biometric integrity of the finger applied to the biometric sensor 100b, 100c, 100d, and 100e. In one implementation, the biometric integrity of the finger can be verified by acquiring a cardiac pulse of the finger. For example, an oximetry procedure can be utilized for acquiring a cardiac pulse. For example, a pulse oximeter can be utilized to conduct the oximetry procedure. Other biometric integrity verification procedures can also be used.

Stage 304 monitors for an application continuity of the finger during the verifying and receiving steps. For example, the monitoring device 116 can monitor for an application continuity of the finger during the verifying and receiving steps. The monitoring device 116 can, for example, measure electrical signals, such as an impedance, a voltage, a current, or a capacitance at an electrical signal sensor 118 to monitor for an application continuity of the finger during the verifying and receiving steps. In other implementations, the monitoring device 116 can, for example, measure pressure with a pressure sensor 120 and/or temperature with a temperature sensor 122 to monitor for an application continuity of the finger during the verifying and receiving steps.

Stage 306 determines whether an interruption of the application of the finger has occurred based on the monitoring in stage 304. For example, if stage 304 determines that an interruption has occurred, stage 308 can provide an indication.

If Stage 304 determines that an interruption has not occurred, stage 310 receives biometric data responsive to a fingerprint swipe. For example, the processing device 110 and the data store 112 can receive the biometric data from the biometric sensor 100b, 100c, 100d and 100e, and determine or authenticate the fingerprint of the finger occurring during the fingerprint swipe.

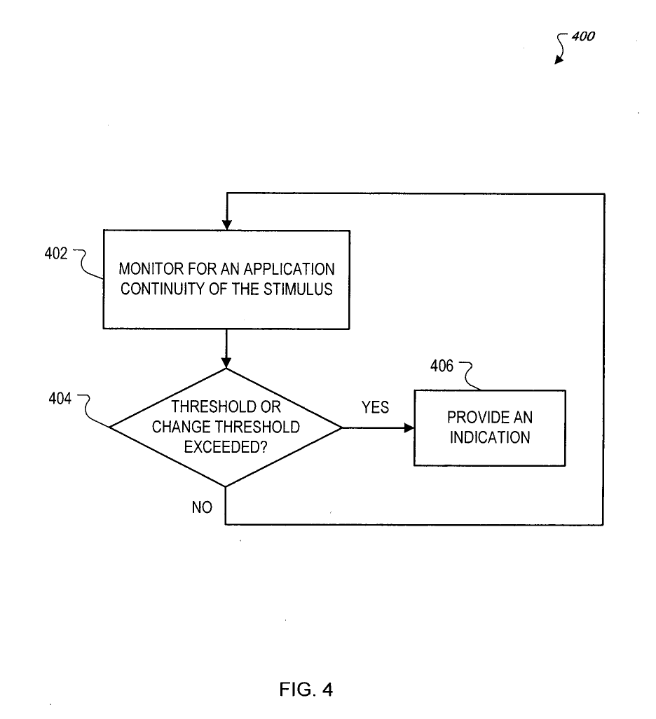

FIG. 4 is a flow diagram of an example process 300 for monitoring for an application continuity of a stimulus. The example process can, for example, be implemented in the biometric sensor 100b, 100c, 100d and 100e of FIGS. 1B, 1C, 1D, and 1E, or in other biometric processing systems.

Stage 402 monitors for an application continuity of the stimulus. In one implementation, an electrical signal can be monitored. For example, the monitored electrical signals can include an impedance, capacitance, voltage, or current. The electrical signals can, for example, be monitored by an electrical signal sensor 118. In one implementation, it can be determined whether the monitored electrical signal value exceeds a threshold. For example, an electrical signal threshold can be defined based on a range of values, e.g., a minimum value and a maximum value, that the monitored electrical signal may be measured. The electrical signal sensor 118 can, for example, monitor the measured electrical signal values and determine whether at least one of the measured electrical signal values exceeds the threshold, e.g., is measured above or below the range of defined values.

In another implementation, it can then be determined whether a monitored electrical signal value of the finger 50 exceeds a change threshold. For example, an electrical signal change threshold can be predefined. The electrical signal change threshold can indicate a maximum value that the measured electrical signal can change from one measured electrical signal value to the next measured electrical signal value during the verifying and receiving steps. For example, the measured electrical signal values should maintain continuity, without an abrupt change in the measured electrical signal values from one measured electrical signal value to the next measured electrical signal value. The electrical signal sensor 118 can, for example, monitor the measured electrical signal values and determine whether the monitored electrical signal value of the finger exceeds the electrical signal change threshold.

In another implementation, a pressure can be monitored. The pressure of the stimulus, e.g., finger 50, can, for example, be monitored by a pressure sensor 120. In one implementation, it can be determined whether the monitored pressure value exceeds a threshold. For example, a pressure threshold can be defined based on a range of values, e.g., a minimum value and a maximum value, that the monitored pressure may be measured. The pressure sensor 120 can, for example, monitor the measured pressure values and determine whether at least one of the measured pressure values exceeds the threshold, e.g., is measured above or below the range of defined values.

In another implementation, it can then be determined whether a monitored pressure value of the finger 50 exceeds a change threshold. For example, a pressure change threshold can be predefined. The pressure change threshold can indicate a maximum value that the measured pressure can change from one measured pressure value to the next measured pressure value during the verifying and receiving steps. For example, the measured pressure values should maintain continuity, without an abrupt change in the measured pressure values from one measured pressure value to the next measured pressure value. The pressure sensor 120 can, for example, monitor the measured pressure values and determine whether the monitored pressure value of the finger exceeds the pressure change threshold.

In another implementation, a temperature can be monitored. The temperature of the stimulus, e.g., finger 50, can, for example, be monitored by a temperature sensor 122. In one implementation, it can be determined whether the monitored temperature value exceeds a threshold. For example, a temperature threshold can be defined based on a range of values, e.g., a minimum value and a maximum value, that the monitored temperature may be measured. The temperature sensor 122 can, for example, monitor the measured temperature values and determine whether at least one of the measured temperature values exceeds the threshold, e.g., is measured above or below the range of defined values.

In another implementation, it can then be determined whether a monitored temperature value of the finger 50 exceeds a change threshold. For example, a temperature change threshold can be predefined. The temperature change threshold can indicate a maximum value that the measured temperature can change from one measured temperature value to the next measured temperature value during the verifying and receiving steps. For example, the measured temperature values should maintain continuity, without an abrupt change in the measured temperature values from one measured temperature value to the next measured temperature value during discrete time periods. The temperature sensor 122 can, for example, monitor the measured temperature values and determine whether the monitored temperature value of the finger exceeds the temperature change threshold.

Stage 404 determines whether an interruption of the application of the stimulus has occurred based on the monitoring in Stage 402. For example, if Stage 404 determines that an electrical signal threshold, electrical signal change threshold, pressure threshold, pressure change threshold, temperature threshold, or temperature change threshold has been exceeded, it can be determined that an interruption has occurred. If an interruption does occur, stage 406 can provide an indication. For example, the indication can be provided by the biometric sensor 100b, 100c, 100d, and 100e to a user. In one implementation, the indication can be a color signal. In another implementation, the indication can be a digital message that can be displayed. In another implementation, the indication can be an audible alert that can be generated.

If Stage 404 determines that an electrical signal threshold, electrical signal change threshold, pressure threshold, pressure change threshold, temperature threshold, or temperature change threshold has not been exceeded, process 400 returns to stage 402.

The apparatus, methods, flow diagrams, and structure block diagrams described herein can be implemented in computer processing systems including program code comprising program instructions that are executable by the computer processing system. Other implementations can also be used, such as hardware implementations or a combination of hardware and software implementations. Additionally, the flow diagrams and structure block diagrams described herein, which describe particular methods and/or corresponding acts in support of steps and corresponding functions in support of disclosed structural means, may also be utilized to implement corresponding software and/or hardware structures and algorithms, and equivalents thereof.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A method, comprising:
verifying a biometric integrity of a stimulus applied to a biometric sensor;
receiving biometric data from the biometric sensor responsive to a physical characteristic of the stimulus occurring during a sensing event; and
monitoring for an application continuity of the stimulus during the verifying and receiving steps.

2. The method of claim 1, wherein verifying a biometric integrity of a stimulus applied to a biometric sensor comprises:
acquiring a cardiac pulse of the stimulus applied to the biometric sensor.

3. The method of claim 1, comprising:
providing an indication in response to verifying the biometric integrity of the stimulus.

4. The method of claim 3, wherein the indication comprises at least one of:
a color signal;
a message; or
an audible alert.

5. The method of claim 3, wherein the indication comprises:
a notification to proceed with the sensing event.

6. The method of claim 1, wherein the physical characteristic of the stimulus comprises:
a fingerprint.

7. The method of claim 1, wherein the sensing event comprises:
a fingerprint swipe.

8. The method of claim 1, wherein monitoring for an application continuity of the stimulus during the verifying and receiving steps comprises:
monitoring for an uninterrupted application of the stimulus.

9. The method of claim 1, wherein monitoring for an application continuity of the stimulus during the verifying and receiving steps comprises:
providing an indication if the application of the stimulus is interrupted during the verifying and receiving steps.

10. The method of claim 1, wherein monitoring for an application continuity of the stimulus during the verifying and receiving steps comprises:
monitoring an electrical signal at the biometric sensor during the verifying and receiving steps; and
determining if the electrical signal exceeds an electrical signal threshold during the verifying and receiving steps.

11. The method of claim 10, wherein the monitored electrical signal comprises at least one of:
an impedance;
a resistance; or
a capacitance.

12. The method of claim 1, wherein monitoring for an application continuity of the stimulus during the verifying and receiving steps comprises:
monitoring a pressure of the stimulus at the biometric sensor during the verifying and receiving steps; and
determining if a pressure change exceeds a pressure change threshold during the verifying and receiving steps.

13. The method of claim 1, wherein monitoring for an application continuity of the stimulus during the verifying and receiving steps comprises:
monitoring a temperature of the stimulus at the biometric sensor during the verifying and receiving steps; and
determining if a temperature change exceeds a temperature change threshold during the verifying and receiving steps.

14. A method, comprising:
verifying a biometric integrity of a finger applied to a biometric sensor;
receiving biometric data from the biometric sensor responsive to a fingerprint of the finger occurring during a fingerprint swipe;
monitoring for an application continuity of the finger during the verifying and receiving steps; and
providing an indication if the application of the finger is interrupted during the verifying and receiving steps.

15. The method of claim 14, comprising:
providing an indication in response to verifying the biometric integrity of the finger.

16. The method of claim 15, wherein the indication comprises:
one or more alerts to a user to proceed with the fingerprint swipe.

17. The method of claim 14, comprising:
repeating the verifying and receiving steps if the application of the finger is interrupted during the verifying and receiving steps.

18. The method of claim 14, wherein monitoring for an application continuity of the finger during the verifying and receiving steps comprises:
monitoring an electrical signal at the biometric sensor during the verifying and receiving steps; and
determining if the electrical signal exceeds an electrical signal change threshold during the verifying and receiving steps.

19. The method of claim 18, wherein the monitored electrical signal comprises at least one of:
an impedance; or
a capacitance.

20. The method of claim 14, wherein monitoring for an application continuity of the finger during the verifying and receiving steps comprises:
monitoring a pressure of the finger at the biometric sensor during the verifying and receiving steps; and
determining if the pressure of the finger exceeds a pressure change threshold during the verifying and receiving steps.

21. The method of claim 14, wherein monitoring for an application continuity of the finger during the verifying and receiving steps comprises:
monitoring a temperature of the finger at the biometric sensor during the verifying and receiving steps; and
determining if the temperature of the finger exceeds a temperature change threshold during the verifying and receiving steps.

22. A system, comprising:
a biometric sensor configured to:
verify a biometric integrity of a stimulus; and
generate biometric data in response to a physical characteristic of the stimulus occurring during a sensing event; and
a monitoring device in communication with the biometric sensor and configured to monitor for an application continuity of the stimulus.

23. The system of claim 22, wherein the biometric sensor comprises a biometric integrity device.

24. The system of claim 23, wherein the biometric integrity device comprises a pulse oximeter.

25. The system of claim 22, wherein the biometric sensor is configured to generate a signal in response to verifying the biometric integrity of the stimulus.

26. The system of claim 22, wherein the monitoring device comprises one or more electrodes to monitor for an application continuity of the stimulus.

27. The system of claim 26, wherein the monitoring device is configured to generate an indication in response to a determination that the application of the stimulus is interrupted.
